(19) United States
(12) Patent Application Publication
(10) Pub. No.: US 2002/0192528 A1
(43) Pub. Date: Dec. 19, 2002

(54) Use of compositions which can be crosslinked to give degradation-stable silicone rubbers as sealing compositions in fuel cells

(76) Inventors: Torsten Sixt, Burghausen (DE); Erhard Bosch, Winhoering (DE); Martina Haering, Burghausen (DE); Wolfgang Schuett, Neufahrn b. Freising (DE)

Correspondence Address: William G. Conger, Brooks & Kushman P.C., 22nd Floor, 1000 Town Center, Southfield, MI, 48075-1351, US

(21) Appl. No.: 10/153,074

(22) Filed: May 21, 2002

(30) Foreign Application Priority Data
May 23, 2001 (DE) 101 25 360.5

(51) Int. Cl. H01M 2/08; B05D 5/12; H01M 8/04

(52) U.S. Cl. 429/35; 429/36; 427/115

(57) ABSTRACT

The invention describes the use of compositions, which can be crosslinked to give elastomers, based on

component (A) comprising polyorganosiloxane (I) having at least two alkenyl groups per molecule and catalyst (IV); and

component (B) comprising polyorganosiloxane (II) having at least two Si-bonded hydrogen atoms per molecule and additive (III) chosen from the group consisting of organic or organosilicon sulfur compounds, as sealing composition in fuel cells or fuel cell stacks.

### BACKGROUND OF THE INVENTION

1. Field of the Invention

The invention relates to the use of compositions which can be crosslinked to give silicone elastomers suitable for use as sealing compositions in fuel cells or fuel cell stacks.

2. Background Art

Fuel cells with polymer electrolyte membranes (PEM) or stacks of a variable number of such fuel cells may be used to generate an electric current from a combustible gas and an oxidant. The fuel cells comprise an anode, a cathode and an ion exchange membrane inbetween, as shown in FIG. 1. Catalytically active layers (2, 3) are applied to both sides of the membrane (1), for example as disclosed in U.S. Pat. No. 6,020,083. Between this membrane electrode unit (MEA) and the bipolar plates (7, 8) it is necessary to construct a gastight space, serving as gas diffusion layers from gas-permeable porous materials (5, 6) e.g. graphite paper or nonwoven (WO 98/50973), which ensure uniform gas diffusion.

For the operation of the cells or stacks of cells, it is necessary to seal the gas-bearing layers from the outside. It is known, depending on the design of the cells, to use elastomers and various plastics for this purpose, for example as vulcanizable compositions or as a preformed seal. If the aim is also to seal gas diffusion layers, then it is necessary to employ vulcanizable elastomers which can penetrate into the porous material, seal it, and at the same time as constructing a stack, perform the function of a seal. According to WO 00/54352 elastomers are poured or sprayed directly onto the MEA/GDL unit (GDL=gas diffusion layer). This arrangement is placed between the bipolar plates with the gas diffusion channels. Mechanical compression during the assembly of the fuel cell stacks results in creating the seal.

For all the hitherto described fuel cell seals, thermoplastics (PP, PE, PA) and elastomers such as fluorinated elastomers (U.S. Pat. No. 6,020,083), silicones (WO 00/54352, DE-A 19829142, WO 00/35038) and other polymers, for example olefinic rubbers such as ethylene propylene rubber, acrylic rubber, butyl rubber, halogenated butyl rubber or hydrogenated nitrile rubber (EP-A 933826), are used. Moreover, epoxy resins (WO 98/33225) can also be used.

The materials used hitherto have disadvantages such as high costs (fluoroelastomers), unfavorable crosslinking parameters (olefinic rubbers) or inadequate resistance to the conditions prevailing in the fuel cell. These include thermal resistance up to about 150° C., resistance to gases water-saturated by moistening (hydrogen/compressed air or oxygen), pressure resistance based on the operating pressures in the fuel cells up to 3 bar, and acid resistance based on acidic conditions at the boundary layer to the polymer membrane. Silicone sealants are advantageous under these conditions. The use of moisture-vulcanizing RTV-1 systems has disadvantages with regard to the cycle time, and condensation-crosslinking RTV-2 systems are disadvantageous primarily due to long pot lives and reversion tendency. The advantage of addition-crosslinking silicone compositions with regard to cycle time or reversion is offset by problems such as degradation during operation of the fuel cells. These problems become evident from white discoloration, clouding, bubble formation and porosity. DE-A 196 34 971 and the corresponding U.S. Pat. No. 5,977,249 describe a liquid silicone rubber with improved compression set based on an addition-crosslinking silicone composition which comprises an organic sulfur compound.

It would be desirable to provide compositions which crosslink to give elastomers, for which the above-described disadvantages are avoided; which are permanently degradation-stable, in particular under the operating conditions of fuel cells such as fuel cells with polymer electrolyte membranes; which have typical processing possibilities of low-viscosity sealing compositions such as injection molding; and which simultaneously permit a reliable seal. These and other objects are achieved by the present invention.

### SUMMARY OF THE INVENTION

The invention provides for the use of compositions which can be crosslinked to give elastomers, preferably based on component (A) comprising polyorganosiloxane (I) having at least two alkenyl groups per molecule and catalyst (IV), and component (B) comprising polyorganosiloxane (II) having at least two Si-bonded hydrogen atoms per molecule and additive (III) chosen from the group consisting of organic or organosilicon sulfur compounds, as sealing compositions in fuel cells or fuel cell stacks.

### DETAILED DESCRIPTION OF THE PREFERRED EMBODIMENT(S)

Necessary ingredients in the curable elastomer formulations include an alkenyl-functional polyorganosiloxane (I), an SiH-functional polyorganosiloxane (II), a hydrosilylation catalyst (IV), and an additive (III). The formulations are most preferably two component systems employing a component (A) and a component (B).

Component (A) preferably comprises polyorganosiloxane (I) and catalyst (IV). Polyorganosiloxane (I) of the silicone rubber compositions is a polyorganosiloxane which contains at least two alkenyl groups per molecule and preferably has a viscosity at 25° C. in the range from 0.5 to 200 Pa·s, more preferably from 2 to 100 Pa·s and most preferably 5 to 50 Pa·s. Polyorganosiloxane (I) is used in amounts which are preferably between 10-98% by weight and more preferably between 70-80% by weight, in each case based on the total weight of component A. Component (A) can also comprise further additives as listed below.

Component (B) preferably comprises polyorganosiloxane (II), an additive (III) and can also additionally comprise polyorganosiloxane (I), as well as further additives as listed below. Polyorganosiloxane (II) of the silicone rubber compositions is a polyorganosiloxane containing at least two Si—H groups per molecule and preferably having a viscosity at 25° C. in the range from 20 to 1,000 mpPa·s, more preferably from 10 to 100 mPa·s.

The polyorganosiloxane (I) preferably comprises units of the formula

RₐR¹_{b}SiO_{(4-a-b)/2,}

where R is an alkenyl radical,

R¹ is a monovalent, optionally substituted hydrocarbon radical having 1 to 10 carbon atom(s) per radical,

a is 0, 1 or 2 and b is 0, 1, 2 or 3,

with the proviso that at least two radicals R are present in each molecule and the sum (a+b) is <4.

Alkenyl radicals R which can be chosen are all alkenyl radicals reactive in a hydrosilylation reaction with an SiH-functional crosslinking agent. Preference is given to using alkenyl radicals having 2 to 6 carbon atoms, such as vinyl, allyl, methallyl, 1-propenyl, 5-hexenyl, ethynyl, butadienyl, hexadienyl, cyclopentenyl, cyclopentadienyl and cyclohexenyl radicals, preferably vinyl and allyl radicals.

R¹ represents a substituted or unsubstituted, aliphatically saturated or aromatic monovalent hydrocarbon radical having 1 to 10 carbon atoms, preferably 1 to 6 carbon atoms. Examples thereof are alkyl radicals, preferably those such as the methyl, ethyl, propyl, butyl and hexyl radicals, cycloalkyl radicals such as the cyclopentyl, cyclohexyl and cycloheptyl radicals; aryl and alkaryl radicals such as the phenyl, tolyl, xylyl, mesityl, benzyl, beta-phenylethyl and naphthyl radicals; halogen-substituted radicals such as the 3,3,3-trifluoropropyl radical, the o-, p- and m-chlorophenyl radicals, and the bromotolyl radical; and cyano-substituted radicals such as the beta-cyanoethyl radical. Preference is given to the methyl radical.

The structure of the polyorganosiloxanes which contain alkenyl groups may be linear or branched. Branched polyorganosiloxanes, in addition to monofunctional units such as RR¹₂SiO_{½} and R¹₃SiO_{½} and difunctional units, such as R¹₂SiO_{2/2} and RR¹SiO_{2/2}, also contain trifunctional units such as R¹SiO_{3/2} and RSiO_{3/2} and/or tetrafunctional units of the formula SiO_{4/2}, where R and R¹ have the meanings given above. The content of the tri- and/or tetrafunctional units which lead to branched polyorganosiloxanes should not significantly exceed 20 mol %. The polyorganosiloxane containing alkenyl groups can also contain units of the general formula —OSi(R²R³)R⁴Si(R²R³)O—, where both R² and R³ have the meanings given above for R and R¹, and R⁴ is a divalent organic radical, such as ethylene, propylene, phenylene, diphenylene or polyoxymethylene. Such units may be present in a proportion up to 50 mol % in the polyorganosiloxane (I).

The alkenyl groups may be bonded in any position of the polymer chain, in particular to the terminal silicon atoms. Polyorganosiloxane (I) can also be a mixture of polyorganosiloxanes which contain different alkenyl groups, which differ, for example, by virtue of the alkenyl group content, the nature of the alkenyl group, or structurally.

Particular preference is given to the use of polydimethylsiloxanes which contain vinyl groups and are of the formula

(ViMe₂SiO_{½})₂(ViMeSiO)ₐ(Me₂SiO)_{b}

where Vi is a vinyl radical, Me is a methyl radical, a is zero or a non-negative integer and b is a non-negative integer and the following relationships are satisfied: 50<(a+b)<2,200, preferably 200<(a+b)<1,000.

The crosslinker used in the addition crosslinking of the silicone rubber composition according to the invention is polyorganosiloxane (II) which is preferably an SiH-functional polyorganosiloxane which is constructed from units of the following formula

H_{c}R¹_{d}SiO_{(4-c-d)/2,}

where c is 0, 1 or 2, d is 0, 1, 2 or 3, with the proviso that the sum (c+d) is <4 and that at least two silicon-bonded hydrogen atoms are present per molecule and R¹ has the meaning given above for polyorganosiloxane (I).

Preference is given to the use of a polyorganosiloxane containing three or more SiH bonds per molecule. If a polyorganosiloxane (II) which has only two SiH bonds per molecule is used, the polyorganosiloxane (I) which contains alkenyl groups preferably contains at least three alkenyl groups per molecule.

The polyorganosiloxane (II) is used as a crosslinker. The hydrogen content of the crosslinker, which refers exclusively to the hydrogen atoms bonded directly to silicon atoms, is in the range from 0.002 to 1.7% by weight of hydrogen, preferably between 0.1 and 1.0% by weight of hydrogen.

The polyorganosiloxane (II) preferably contains at least three and preferably at most 300 silicon atoms per molecule. Particular preference is given to the use of SiH crosslinkers which contain between 4 and 100 silicon atoms per molecule.

The structure of the polyorganosiloxane (II) may be linear, branched, cyclic or network-like. Linear and cyclic polyorganosiloxanes (II) are composed of units of the formula HR¹₂SiO_{½}, R¹₃SiO_{½}, HR¹SiO_{2/2} and R¹₂SiO_{2/2}, where R¹ has the meaning given above for it. Branched and network-like polyorganosiloxanes (II) additionally contain trifunctional units, such as HSiO_{3/2} and R¹SiO_{3/2} and/or tetrafunctional units of the formula SiO_{4/2}. As the content of tri- and/or tetrafunctional units increases, these crosslinking agents have a network-like, resinous structure. The organic radicals R¹ present in the polyorganosiloxane (II) are usually chosen so that they are compatible with the organic radicals in the polyorganosiloxane (I), so that the constituents (I) and (II) are miscible. The crosslinkers which can be used also include combinations and mixtures of the polyorganosiloxanes (II) described here.

Preferred polyorganosiloxanes (II) are those of the general formula

HₑR¹₃₋ₑSiO(SiR¹₂O)_{g}(SiHR¹O)_{b}SiR¹₃₋ₑHₑ

where R¹ has the meaning given above,

e is 0, 1 or 2,

g is 0 or an integer from 1 to 1,000 and

h is 0 or an integer from 1 to 200,

with the proviso that at least two Si-bonded hydrogen atoms are present per molecule.

The polyorganosiloxane (II) is preferably present in the curable silicone rubber composition in an amount such that the molar ratio of SiH groups in polyorganosiloxane (II) to alkenyl groups in polyorganosiloxane (I) is preferably between 0.5 and 5, more preferably between 1.0 and 3.0. Polyorganosiloxane (II) is preferably used in amounts of from 0.1 to 30% by weight, preferably in amounts of from 10 to 20% by weight, in each case based on the total weight of component B.

The catalyst (IV), which is preferably present in component (A), serves for the addition reaction (hydrosilylation) between the alkenyl groups of the polyorganosiloxane (I) and the silicon-bonded hydrogen atoms of the polyorganosiloxane (II). Numerous suitable hydrosilylation catalysts (IV) have been described in the literature. In principle, it is possible to use all hydrosilylation catalysts customarily used in addition-crosslinking silicone rubber compositions.

Hydrosilylation catalysts (IV) which may be used preferably include metals such as platinum, rhodium, palladium, ruthenium or iridium, preferably platinum, optionally fixed to finely divided carrier materials.

Preference is given to using platinum and platinum compounds. Particular preference is given to using those platinum compounds which are soluble in polyorganosiloxanes. Soluble platinum compounds which can be used are, for example, the platinum-olefin complexes of the formulae (PtCl₂.olefin)₂ and H(PtCl₃.olefin), preference being given to using alkenes having 2 to 8 carbon atoms, such as ethylene, propylene, isomers of butene and octene, or cycloalkenes having 5 to 7 carbon atoms, such as cyclopentene, cyclohexene and cycloheptene. Further soluble platinum catalysts are the platinum-cyclopropane complex of the formula (PtCl₂.C₃H₆)₂, the reaction products of hexachloroplatinic acid with alcohols, ethers and aldehydes or mixtures thereof, or the reaction product of hexachloroplatinic acid with methylvinylcyclotetrasiloxane in the presence of sodium bicarbonate in ethanolic solution. Finely divided platinum on carrier materials such as silicon dioxide, aluminum oxide or activated wood or animal charcoal, platinum halides, such as PtCl₄, hexachloroplatinic acid and Na₂PtCl₄.nH₂O, platinum-olefin complexes, e.g. those with ethylene, propylene or butadiene, platinum-alcohol complexes, platinum-styrene complexes, as described in U.S. Pat. No. 4,394,317, platinum-alkoxide complexes, platinum acetylacetonates, reaction products of chloroplatinic acid and monoketones, e.g. cyclohexanone, methyl ethyl ketone, acetone, methyl n-propyl ketone, diisobutyl ketone, acetophenone and mesityl oxide, and also platinum-vinylsiloxane complexes, for example the platinum-vinylsiloxane complexes described in U.S. Pat. Nos. 3,715,334, 3,775,452 and U.S. Pat. No. 3,814,730, such as platinum-divinyltetramethyldisiloxane complexes with or without detectable amounts of inorganic halogen.

The hydrosilylation catalyst (IV) is used in an amount which suffices to promote curing of the composition at a temperature preferably in the range of ambient temperature to 250° C., where the organohydrogensiloxane (II) and the hydrosilylation catalyst (IV) are contained in different parts of the multipart curable composition. Particular preference is given to complexes of platinum with vinylsiloxanes, such as sym-divinyltetramethyldisiloxane.

The hydrosilylation catalyst (IV) can also be used in microencapsulated form, where the solid encapsulant present with the catalyst and insoluble in the polyorganosiloxane is, for example, a thermoplastic such as, but not limited to, polyester resins and silicone resins. The hydrosilylation catalyst can also be used in the form of an inclusion compound, for example in a cyclodextrin.

The amount of hydrosilylation catalyst (IV) used depends on the desired crosslinking rate and economic considerations. If a customary platinum catalyst is used, the content of platinum metal in the curable silicone rubber composition is preferably in the range from 0.1 to 500 ppm by weight (ppm=parts per million parts), preferably between 10 and 100 ppm by weight of platinum metal, in each case based on the total weight of the composition. Otherwise, the catalyst is optionally used together with an inhibitor, preferably in amounts of from 0.01 to 5% by weight.

The additive (III) is an organic sulfur or organosilicon sulfur compound, present in at least one part of the multipart composition, preferably the H-siloxane-containing part, and can also be applied or bonded to an inorganic filler, such as silica, e.g. highly disperse silicon dioxide.

Examples of organic sulfur compounds as additive (III) are thiols (mercaptans) such as alkylthiols, arylthiols, mercaptoheterocycles such as mercaptoimidazoles and mercaptobenzimidazoles, keten-S,X-acetals where X is preferably N or S, thioacetals, sulfanes (thioethers), disulfanes (dithioethers), polysulfanes, thioamides, thioureas, thiurams such as thiuram mono-, di- or polysulfides and bisthiocarbomoyl mono-, di- or polysulfanes, thiuronium salts, thiocarbamates, dithiocarbamates and the Zn, Fe, Ni, Co or Cu salts thereof, thiocyanates, isothiocyanates, thiocarbonyl compounds such as thioaldehydes, thioketones, thiolactones, and thiocarboxylic acids, and thiaheterocycles such as thiophene, 1,2- or 1,3-dithiols or 1,2- or 1,3-dithiolthiones, thiazoles, mercaptothiazoles, mercaptothiadiazoles, benzodithiols or benzodithiolthiones, benzthiazoles, mercaptobenzthiazoles, phenothiazines and thianthrenes.

Examples of organosilicon sulfur compounds as additive (III) are organosilicon compounds with sulfur-containing functional groups, such as silanes with sulfur-containing functional groups, e.g. a mercaptoalkyl-alkyl-alkoxysilanes of the general formula (4),

(R⁵O)₃₋ₘR⁶ₘSi—R⁷—SH (4)

preferably 3-mercaptopropyltrimethoxysilane and 3-mercaptopropyltriethoxysilane, bis(trialkoxysilyl-alkyl)mono-, di- or polysulfanes of the general formula (5),

[(R⁸O)₃Si—R⁹—]₂—Sₙ (5)

thiocyanatoalkyltrialkoxysilanes of the general formula (6),

(R¹⁰O)₃Si—R¹¹—SCN (6)

and thiofunctional siloxanes, a copolymer of trimethylsiloxane units, dimethylsiloxane units and methylmercaptoalkylsiloxane units, such as methyl-2-mercaptoethylsiloxane units and methyl-3-mercaptopropylsiloxane units, and inorganic fillers, preferably silicas, e.g. highly disperse silicon dioxide, onto/with which these organosilicon compounds with sulfur-containing functional groups have been applied, reacted, or mixed, preferably applied and/or bonded.

R⁵ is a substituted or unsubstituted, aliphatically saturated, monovalent hydrocarbon radical having 1 to 10 carbon atoms, preferably 1 to 6 carbon atoms. Examples thereof are preferably alkyl radicals such as the methyl, ethyl, propyl, butyl and hexyl radicals, and cycloalkyl radicals such as cyclopentyl, cyclohexyl and cycloheptyl radicals.

R⁶ is a substituted or unsubstituted, aliphatically saturated, monovalent hydrocarbon radical having 1 to 10 carbon atoms, preferably 1 to 6 carbon atoms. Examples thereof are alkyl radicals, such as the methyl, ethyl, propyl, butyl and hexyl radicals; cycloalkyl radicals such as the cyclopentyl, cyclohexyl and cycloheptyl radicals; and aryl and alkaryl radicals such as the phenyl, tolyl, xylyl, mesityl and benzyl radicals.

R⁷ is a substituted or unsubstituted, aliphatically saturated bivalent hydrocarbon radical having 1 to 10 carbon atoms, preferably 1 to 6 carbon atoms. Examples thereof are alkylene radicals such as the methylene, ethylene, propylene, butylene, hexylene and phenylene radicals, more particularly preferably the propylene radical.

R⁸ and R¹⁰ have the meaning of R⁵,

R⁹ and R¹¹ have the meaning of R⁷,

m is 0, 1, 2 or 3, preferably 0, and

n is an integer from 1 to 10, preferably 2 or 4.

It is also possible to use mixtures of the additives (III). The additives (III) or their mixtures are used in amounts of 0.0001-2% by weight, preferably 0.001-0.2% by weight, particularly preferably 0.005-0.15% by weight, based on the total weight of the compositions.

In the components A or B, the following additives may also be present. While the constituents (I) to (IV) are necessary constituents of the silicone rubber composition according to the invention, if desired, further additives may be present in an amount of up to 60% by weight, preferably between 10 and 40% by weight, in the silicone rubber composition. These additives can, for example, be fillers, adhesion promoters, inhibitors, metal dusts, fibers, pigments, dyes, plasticizers etc.

Examples of fillers are reinforcing fillers, preferably a reinforcing inorganic silaceous filler such as highly disperse silicon dioxide (silica) with a specific surface area of 50-500 m²/g, preferably 150-300 m²/g, which may optionally be surface-modified. These fillers can be prepared, for example, by precipitation from solutions of silicates with inorganic acids, by hydrothermal digestion, by hydrolytic and/or oxidative high-temperature reaction of volatile silicon halides, or by a luminous arc process. These silicas can optionally also be in the form of mixed oxides or oxide mixtures with the oxides of other metals such as aluminum, magnesium, calcium, barium, zinc, zirconium and/or titanium. In addition, it is possible to use non-reinforcing fillers, i.e. fillers with a BET specific surface area of less than 50 m²/g, such as quartz flour, diatomaceous earth, calcium silicate, zirconium silicate, zeolites, metal oxides such as iron oxide, zinc oxide, titanium dioxide, or aluminum oxide, metal carbonates such as calcium carbonate, magnesium carbonate, or zinc carbonate, metal sulfates, mica, siloxane resins, clays, lithophones, graphite or chalk. All these fillers may optionally be hydrophobicized. Synthetic silicates, natural silicates, glass fibers and glass fiber products such as mats, strands, wovens, nonwovens and the like, and also microglass spheres (microballoons) can be used. Preference is given to adding 10 to 60%, based on the weight of the compositions, of filler.

Carbon black may additionally be present in the rubber compositions according to the invention, not only to color the vulcanizates gray or black, but also to achieve particularly valuable vulcanization properties, preference being given to the known rubber carbon blacks. The carbon black is preferably used in amounts of from 0 to 35 parts by weight, based on 100 parts by weight of rubber, in at least one part of the multipart composition. A lower limit with the number zero means, for the purposes of the present invention, that the mixing constituent may be present in the rubber mixture, but does not have to be. If carbon black is present in a mixture, the lower limit is, in practice, about 0.1 part by weight.

Examples of plasticizers are diorganopolysiloxanes which are liquid at room temperature and are terminally capped by triorganosiloxy groups, such as dimethylpolysiloxanes terminally capped by trimethylsiloxy groups and having a viscosity of from 10 to 10,000 mPa·s at 25° C.

In particular, resin-like polyorganosiloxanes, which consist primarily of units of the formulae R¹²₃SiO_{½}, R¹²SiO_{3/2} and/or SiO_{4/2}, optionally also R¹²₂SiO_{2/2}, may be present up to an amount of 60% by weight, preferably up to 40% by weight, based on the total weight of the silicone rubber compositions. The molar ratio between monofunctional and tri- or tetrafunctional units in these resin-like polyorganosiloxanes is preferably in the range from 0.5:1 to 1.5:1. Functional groups, in particular alkenyl groups, in the form of R¹³R¹²₂SiO_{½} and/or R¹³R¹²SiO_{2/2} units, may also be present.

R¹² is a substituted or unsubstituted aliphatically saturated monovalent hydrocarbon radical having 1 to 10 carbon atoms, preferably 1 to 6 carbon atoms. Examples thereof are alkyl radicals such as the methyl, ethyl, propyl, butyl and hexyl radicals; cycloalkyl radicals such as the cyclopentyl, cyclohexyl and cycloheptyl radicals; aryl and alkaryl radicals such as the phenyl, tolyl, xylyl, mesityl, benzyl, beta-phenylethyl and naphthyl radicals, halogen-substituted radicals such as the 3,3,3-trifluoropropyl, o-, p- and m-chlorophenyl and bromotolyl radicals, and the beta-cyanoethyl radical.

R¹³ is an alkenyl radical. Alkenyl radicals which may be mentioned are any alkenyl radicals reactive in a hydrosilylation reaction with an SiH-functional crosslinking agent. Preference is given to using alkenyl radicals having 2 to 6 carbon atoms such as the vinyl, allyl, methallyl, 1-propenyl, 5-hexenyl, ethynyl, butadienyl, hexadienyl, cyclopentenyl, cyclopentadienyl, and cyclohexenyl radicals, preferably vinyl and allyl radicals.

In particular, additives which serve for the desired adjustment of the processing time and crosslinking rate of the curable silicone rubber composition may be present. These inhibitors and stabilizers are per se known and include, for example: acetylenic alcohols such as ethynylcyclohexanol and 2-methyl-3-butyn-2-ol, polymethylvinylcyclosiloxanes such as methylvinylcyclotetrasiloxane, low molecular weight siloxane oils with vinyldimethylsiloxy end-groups, trialkyl cyanurate, alkyl maleates such as diallyl maleate and dimethyl maleate, alkyl fumarates such as diethyl fumarate and diallyl fumarate, organic hydroperoxides such as cumene hydroperoxide, tert-butyl hydroperoxide and pinane hydroperoxide, organic peroxides, benzotriazole, organic sulfoxides, organic amines and amides, phosphanes, phosphites, nitriles, diaziridines and oximes. Preferably, siloxanes can be used, most preferably 1,3-divinyl-1,1,3,3-tetramethyldisiloxane and tetramethyltetravinylcyclotetrasiloxane.

The silicone rubber compositions according to the invention are preferably prepared by mixing the filler with the polyorganosiloxane(I) which contains alkenyl groups to give a uniform mixture in a first step. The filler is incorporated into the polyorganosiloxane (I) in a suitable mixer, i.e. a kneader.

The components (A) and (B) are used in a weight ratio of preferably 10:1 to 1:0.5, preferably 1:1.

The compositions are preferably vulcanized at the pressure of the ambient atmosphere (1 bar) to a pressure 2,000 bar, more preferably 1 to 200 bar, and most preferably 1 to 50 bar, and preferably at a temperature of room temperature (20° C.) to about 250° C., more preferably 70° C. to 180° C., and in particular 90° C. to 150° C.

The compositions according to the invention are used for the preparation of seals for fuel cells and stacks of fuel cell units, specifically in the area of sealing between bipolar plate and membrane electrode unit (MEA) or gas diffusion layer.

The seals are preferably prepared by the processes customary for the processing of 2-component silicone rubber compositions, such as casting, dip molding, metered addition, injection, injection molding, transfer molding, and compression molding, preference being given to casting, injection and injection molding.

A characteristic of the addition-crosslinking silicone rubber described is that, in contrast to peroxide crosslinking, no crosslinker decomposition products are liberated. Furthermore, addition-crosslinking silicone rubbers have a low viscosity compared with other elastomers such as polyolefins, which is advantageous, for example, for the seal.

This favorable consistency and the addition crosslinking lead to numerous processing advantages, in particular in the case of processes with high cycle rates. A further advantage of the compositions according to the invention is the ability to process without after-treatment, e.g. without post-heating (tempering), which is essential for automated production. A further advantage of the compositions according to the invention is that the elastomers have a low compression set, which is important for a large number of sealing applications. The inventive silicone sealants used for the sealing of fuel cells preferably have a compression set of less than 10, more preferably less than 5. A significant advantage is that the elastomers obtained from the present compositions are degradation-stable under the operating conditions of the fuel cells, i.e. in particular are resistant to hydrogen and air or oxygen which have been moistened with water. For these reasons, the inventive compositions are particularly interesting since the sulfur-containing additives (III) reduce, for the greatest part, the degradation tendency, and significantly improve the compression set, without significantly influencing the other mechanical properties and/or the crosslinking behavior. As a result of the sulfur-containing groups of the additives (III) bonded to the filler, influencing of the catalytically active layer in the fuel cells is avoided.

### EXAMPLES

### Example 1

Preparation of a Filler Modified with Organosulfur Compounds.

10 g of water and then 12.24 g of very finely divided 3-mercaptopropyltrimethoxysilane, obtainable from Wacker-Chemie under the name “Wacker Silan GF 70”, are mixed into 100 g of very finely divided pyrogenic silicon dioxide with a BET specific surface area of 300 m²/g, obtainable from Wacker-Chemie under the name “Wacker HDK T30”, at room temperature and atmospheric pressure and with stirring. The mixture is then tempered for 1 hour at 80° C. Purification by removal of reaction secondary products under reduced pressure gives 106.1 g of a white powder.

### Example 2

Preparation of a Batch for Improving the Resistance Toward Hydrogen/air.

In a kneader, 43.3 parts by weight of polydimethylsiloxane terminally capped with vinyl groups and having a viscosity of 20 Pa·s at 25° C. are mixed with 20 parts by weight of a pyrogenically prepared silicon dioxide surface-modified with hexamethyldisilazane and having a BET specific surface area of 300 m²/g, and processed to give a homogeneous composition. 10 parts by weight of a modified filler according to example 1 are added to this mixture, which is again homogenized for 0.5 hours at 120° C. Finally, 26.7 parts by weight of polydimethylsiloxane which is terminally capped with vinyl groups and has a viscosity of 20 Pa·s at 25° C. are mixed in.

### Example 3

Preparation of the Two Rubber Base Components

Preparation of the A component: In a kneader, 82 parts by weight of polydimethylsiloxane terminally capped with vinyl groups and having a viscosity of 20 Pa·s at 25° C. are mixed with 33 parts by weight of surface-modified pyrogenically prepared silicon dioxide having a BET specific surface area of 300 m²/g and processed to give a homogeneous composition. To 100 parts by weight of this silicone base mixture are added 0.19 g of a platinum catalyst, consisting of 97 parts by weight of a polydimethylsiloxane and 3 parts by weight of a platinum-divinyltetramethyldisiloxane complex, and 0.07 parts by weight of ethynylcyclohexanol as inhibitor, and the mixture is homogenized in a kneader.

Preparation of the B component: In a kneader, 82 parts by weight of polydimethylsiloxane terminally capped with vinyl groups and having a viscosity of 20 Pa·s at 25° C. are mixed with 33 parts by weight of surface-modified pyrogenically prepared silicon dioxide with a BET specific surface area of 300 m²/g and processed to give a homogeneous composition. To 100 parts by weight of this silicone base mixture are added 4 parts by weight of a mixed polymer of dimethylsiloxane, hydrogenmethylsiloxane and trimethylsiloxane units containing 0.37% by weight of Si-bonded hydrogen and 0.03 parts by weight of ethynylcyclohexanol as inhibitor, and the mixture is homogenized in a kneader.

### Example 4

Comparative Experiment

The resulting curable silicone base compositions A and B from Example 3 are mixed in the ratio 1:1. The mixture is introduced into a mold whose molding gives a 0.5 mm-thick film with a sealing edge, and vulcanized at 165° C. for 30 min.

Assessment of degradation was carried out using a measuring device in which films of the silicone vulcanizates were stretched in a device in which heated air with a defined degree of moisture was passed on one side of the film, and heated, moistened hydrogen with a defined volumetric flow rate was passed on the other side. The degradation which arises was assessed visually by observing the cloudiness of the film. The results are summarized in table 1 below.

### Example 5

To 100 parts by weight of the B component as in Example 3 are added 2 parts by weight of the additive batch of Example 2, corresponding to about 0.5 parts by weight of the modified filler of Example 1, and the mixture is vulcanized with the A component of Example 4.

The degradation was assessed as described in Example 4. The results are summarized in table 1 below.

### Example 6

To 100 parts by weight of the B component of Example 3 are added 4 parts by weight of the additive batch of Example 2, and the mixture is vulcanized with the A component of Example 4.

The degradation was investigated as described in Example 4. The results are summarized in Table 1 below.

TABLE 1
Investigation of the degradation

| Material | Period of operation | Result |
|---|---|---|
| Addition-crosslinking silicone rubber | 460 h | 4 |
| without additive (III) (Comparative | 460 h | 5 |
| Example 4) | | |
| Example 5 | 1 000 h | 2 |
| Example 6 | 872 h | 1-2 |
| | 872 h | 1 |

Clouding: 1 none, 2 slight, 3 moderate 4 severe, 5 very severe

The addition-crosslinking silicone rubbers stabilized with the additive according to the invention do not exhibit any clouding (after 872 h) or only slight clouding (after 1 000 h), and are therefore degradation-stable, in contrast to the addition-crosslinking silicone rubber without additive, which has severe to very severe clouding after just 460 h.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for sealing two or more fuel cell components in a fuel cell or fuel cell stack, said process comprising applying a curable elastomeric sealing composition onto at least one component to be sealed or between two components to be sealed, said curable elastomeric sealing composition comprising
component (A) comprising at least one polyorganosiloxane (I) bearing on average at least two alkenyl groups per molecule;
component (B) comprising at least one polyorganosiloxane (II) bearing on average at least two Si-bonded hydrogen atoms per molecule;
an effective amount of hydrosilylation catalyst (IV); and
an additive (III) comprising an organic sulfur compound, an organosilicon sulfur compound, or mixture thereof.

2. The process of claim 1, wherein component (B) also additionally comprises polyorganosiloxane (I).

3. The process of claim 1, wherein the additive (III) is applied and/or bonded to an inorganic filler.

4. The process of claim 1, wherein said elastomeric sealing composition is a two part sealing composition wherein component (A) further comprises catalyst (IV).

5. The process of claim 1, wherein component (B) further comprises additive (III).

6. The process of claim 1, wherein component (A) further comprises catalyst (IV) and component (B) further comprises additive (III).

7. The process of claim 1, wherein the additive (III) is an organosilicon sulfur compound.

8. The process of claim 7, wherein the organosilicon sulfur compound comprises at least one of 3-mercaptopropyltrimethoxysilane, 3-mercaptopropyltriethoxysilane, or a copolymer of dimethylsiloxane units, methyl-3-mercaptopropylsiloxane units, and trimethylsiloxane units.

9. The process of claim 1, wherein the additive (III) is present in an amount of from 0.0001 to 2% by weight, based on the total weight of the sealing composition.

10. The process of claim 6, wherein component (A) is mixed with component (B) and cured.

11. A seal in a fuel cell or a fuel cell stack, said seal comprising a cured sealing composition comprising prior to cure,
component (A) comprising at least one polyorganosiloxane (I) bearing on average at least two alkenyl groups per molecule;
component (B) comprising at least one polyorganosiloxane (II) bearing on average at least two Si-bonded hydrogen atoms per molecule;
an effective amount of hydrosilylation catalyst (IV); and
an additive (III) comprising an organic sulfur compound, an organosilicon sulfur compound, or mixture thereof.

12. The seal of claim 11, wherein component (B) also additionally comprises polyorganosiloxane (I).

13. The seal of claim 11, wherein the additive (III) is applied and/or bonded to an inorganic filler.

14. The seal of claim 11, wherein component (A) further comprises catalyst (IV) and component (B) further comprises additive (III).

15. The seal of claim 11, wherein the additive (III) is an organosilicon sulfur compound.

16. The seal of claim 11, wherein the organosilicon sulfur compound comprises at least one of 3-mercaptopropyltrimethoxysilane, 3-mercaptopropyltriethoxysilane, or a copolymer of dimethylsiloxane units, methyl-3-mercaptopropylsiloxane units, and trimethylsiloxane units.

17. The process of claim 1, wherein the additive (III) is present in an amount of from 0.0001 to 2% by weight, based on the total weight of the sealing composition.

18. In a fuel cell or fuel cell stack having one or more elastomeric seals between fuel cell or fuel cell stack components, the improvement comprising at least one of said one or more elastomeric seals being a seal of claim 11.

19. In a fuel cell or fuel cell stack having one or more elastomeric seals between fuel cell or fuel cell stack components, the improvement comprising at least one of said one or more elastomeric seals being a seal of claim 13.

20. In a fuel cell or fuel cell stack having one or more elastomeric seals between fuel cell or fuel cell stack components, the improvement comprising at least one of said one or more elastomeric seals being a seal of claim 14.
